(19) United States
(12) Patent Application Publication
(10) Pub. No.: US 2010/0168904 A1
(43) Pub. Date: Jul. 1, 2010

(54) UNVERIFIED ORDER PRESENTATION MECHANISM

(75) Inventors: TODD R. HENDERSON, LEAWOOD, KS (US); STEVEN G. KIRSCH, LEAWOOD, KS (US); KATY S. ALLEN, OVERLAND PARK, KS (US); ZACHARY R. FIRL, GRANDVIEW, MO (US)

Correspondence Address: SHOOK, HARDY & BACON L.L.P.;(Cerner Corporation), Intellectual Property Department, 2555 GRAND BOULEVARD, KANSAS CITY, MO, 64108-2613, US

(73) Assignee: CERNER INNOVATION, INC., OVERLAND PARK, KS (US)

(21) Appl. No.: 12/498,037

(22) Filed: Jul. 6, 2009

Related U.S. Application Data
(60) Provisional application No. 61/141,958, filed on Dec. 31, 2008.

(51) Int. Cl. G06F 7/00

(52) U.S. Cl. 700/216

(57) ABSTRACT

Systems, computer-implemented methods, and computer-storage media provide an unverified order presentation mechanism allowing clinicians to view unverified orders alongside verified orders from a particular patient's medication profile. The unverified orders and verified orders may be displayed at a medication dispensing computing device used for dispensing medications from a medication storage and dispensing apparatus. The unverified orders and verified orders are displayed different such that a user can identify which orders are verified and which orders are unverified. In some embodiments, a user can select an unverified order to cause a medication to be dispensed from an associated medication storage and dispensing apparatus.

### CROSS-REFERENCE TO RELATED APPLICATIONS

This application claims the benefit of U.S. Provisional Application No. 61/141,958, filed Dec. 31, 2008, which is herein incorporated by reference in its entirety.

### BACKGROUND

Providers of healthcare services, such as clinicians, prescribe various drugs and other chemical agents (collectively, “medications”) to treat ailments or conditions diagnosed in patients. Increasingly, clinicians are utilizing electronic order management systems to enter and manage medications and other orderables for their patients. One example of such an electronic order management system is the POWERORDERS® application available from Cerner Corporation of Kansas City, Mo. For instance, using such an order management system, a physician or other clinician desiring to prescribe a medication for a particular patient may access a profile for the patient and initiate an order for the medication, entering details for the medication order. After initiating the order, the physician may “sign” the order, indicating to the order management system to process the order. Depending on the robustness of the electronic order management system, other features may be provided to assist healthcare providers in the care process. For instance, when a physician enters a medication order, a system may perform dose range checking to determine whether the dosage entered by the physician is appropriate. In addition, a system may determine and/or warn whether the patient has any allergies to the medication, or whether the medication ordered would interact with another medication already prescribed to the patient (e.g., via accessing information in the patient's electronic medical/health record).

In acute care settings, such as hospitals, surgical centers, and the like, the medication order is then submitted for verification by a pharmacist. The pharmacist typically checks to see that the medication prescribed is an appropriate choice for administering to a patient, and that the dosage administration plan is acceptable. Once this is accomplished, the medication is considered verified, such that the orderable can be dispensed to a patient (e.g., by a nurse or other clinician).

Certain situations arise in care settings where a nurse or other clinician needs to administer an “unverified medication” (i.e., a medication that has not be verified by a pharmacist) to a patient they are treating. For instance, a cardiac patient may need an administration of furosemide to treat edema. In this situation, the clinician understands the risks involved in administering a dose of the unverified medication, such as whether any contraindications are present. Despite such risks, the clinician has determined the benefit to the patient far outweighs the potential risks caused by avoiding full verification by the pharmacy (or prescribing physician) in this particular situation. As another example, a patient may have significant discomfort in a postoperative setting, and be in immediate need of a pain reducing medication, such as morphine. The hospital pharmacy may not have time to verify that the medication itself, or its dosage, is appropriate for this patient under such time constraints. Nevertheless, the clinician—being properly trained to be cognizant of any contraindications for the patient—is deemed to have taken appropriate precautions and, according to the healthcare institution policy, is allowed to administer the unverified medication in this situation (e.g., either without further action or after contacting the prescribing physician for confirmation).

### BRIEF SUMMARY

Embodiments of the present invention relate to displaying unverified medication orders with verified medication orders. The unverified medication orders are displayed using a visual characteristic that differs from the verified medication orders that allows a user to recognize the unverified status of the unverified medication orders. In some embodiments, the unverified medication orders and verified medication orders are displayed by a computing device used to dispense medications from a medication storage and dispensing apparatus. In further embodiments, an unverified medication order may be selected for dispensing an associated medication from the medication storage and dispensing apparatus.

Accordingly, in one aspect, an embodiment of the present invention is directed to one or more computer-storage media storing computer-useable instructions for causing a computing device to perform a method of displaying verified and unverified medication orders, the computing device being operable to control dispensing of medications from a medication storage and dispensing apparatus. The method includes accessing medication order information associated with a patient. The medication order information includes one or more verified medication orders and one or more unverified medication orders. The method also includes displaying at least a portion of the medication order information, wherein each of the one or more unverified medication orders is displayed using at least one visual characteristic that identifies the one or more unverified orders as having an unverified status.

In another embodiment, an aspect of the invention is directed to one or more computer-storage media storing computer-useable instructions for causing a computing device to perform a method of using an unverified medication order for dispensing a medication, the computing device being operable to control dispensing of medications from a medication storage and dispensing apparatus. The method includes displaying a list of medication orders for a patient, wherein the list of medication orders includes one or more verified medication orders and one or more unverified medication orders, and wherein each of the one or more unverified medication orders is displayed using a visual characteristic that identifies the one or more unverified medication orders as having an unverified status. The method also includes receiving a selection of an unverified medication order from the list of medication orders. The method further includes responsive to the selection, causing a medication associated with the selected unverified medication order to be dispensed from the medication storage and dispensing apparatus.

In a further aspect of the invention, an embodiment is directed to one or more computer-storage media storing computer-useable instructions for presenting one or more user interfaces for displaying a medication profile for a particular patient in a particular healthcare encounter. The one or more user interfaces include an order list including medication orders associated with medications prescribed for the particular patient; and a visual characteristic associated with one or more particular medication orders of the order list to indicate said one or more particular medication orders possesses the status of an unverified order.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of a healthcare ordering system in accordance with an embodiment of the present invention;

FIG. 3 is a flow diagram showing a method for presenting unverified medication orders with verified medication orders in accordance with an embodiment of the present invention;

FIG. 4 depicts an illustrative screen display showing unverified medication orders with verified medication orders in accordance with an embodiment of the present invention;

FIG. 5 depicts an illustrative screen display showing unverified medication orders with verified medication orders in accordance with another embodiment of the present invention; and

FIGS. 6A and 6B depict illustrative screen displays showing a non-dispensable unverified medication order and a dispensable unverified medication order in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Systems, computer-implemented methods, and computer-storage media provide an unverified order presentation mechanism allowing clinicians to view unverified orders alongside verified orders from a particular patient's medication profile. In embodiments, the unverified orders and verified orders are displayed at a medication dispensing computing device used for dispensing medications from a medication storage and dispensing apparatus, such as a medication storage cabinet. A particular visual characteristic is applied to the listing of the unverified order in a user interface to differentiate such an order from other verified orders displayed. According to an embodiment, rules may also be established to regulate whether a clinician can retrieve a medication dose associated with an unverified order from the medication storage and dispensing apparatus for administration. Furthermore, in an embodiment, selection of a particular unverified order in the medication profile displayed on the user interface initiates a “dispense” activity on the medication storage and dispensing apparatus, thereby allowing a medication dose associated with the selected unverified order to be retrieved from the medication storage and dispensing apparatus for administration to the patient.

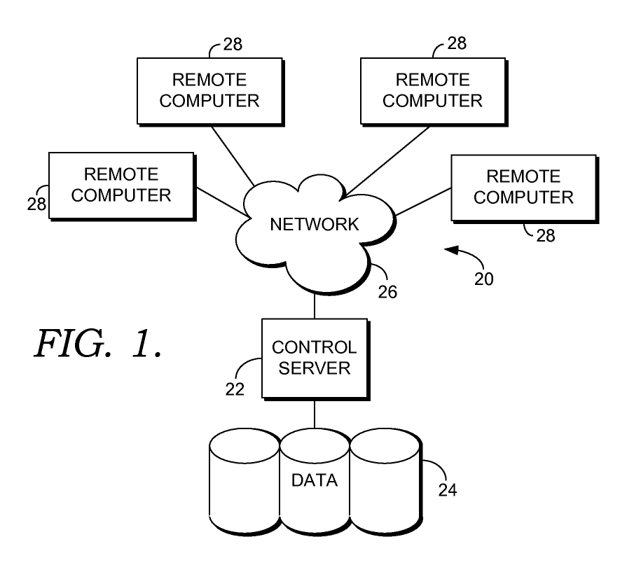

With reference to FIG. 1, an exemplary medical information system 20 for implementing embodiments of the invention includes a general purpose-computing device in the form of server 22. Components of server 22 may include, but are not limited to, a processing unit, internal system memory, and a suitable system bus for coupling various system components, including database cluster 24 to the control server 22. The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Server 22 typically includes therein or has access to a variety of computer readable media, for instance, database cluster 24. Computer readable media can be any available media that can be accessed by server 22, and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information, such as computer readable instructions, data structures, program modules or other data. Computer storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 22. By way of example, and not limitation, communication media includes wired media, such as a wired network or direct-wired connection, and wireless media such as acoustic, RF, infrared and other wireless media. Combinations of any of the above should also be included within the scope of computer readable media.

The computer storage media, including database cluster 24, discussed above and illustrated in FIG. 1, provide storage of computer readable instructions, data structures, program modules, and other data for server 22. Server 22 may operate in a computer network 26 using logical connections to one or more remote computers 28. Remote computers 28 can be located at a variety of locations in a medical or research environment, for example, but not limited to, clinical laboratories, hospitals, other inpatient settings, a clinician's office, ambulatory settings, medical billing and financial offices, hospital administration, veterinary environment and home health care environment. Clinicians and caregivers include, but are not limited to, the treating physician, specialists such as surgeons, radiologists and cardiologists, emergency medical technologists, discharge planners, care planners, physician's assistants, nurse practitioners, nurses, nurse's aides, pharmacists, dieticians, veterinarians and the like. The remote computers may also be physically located in non-traditional medical care environments so that the entire health care community is capable of integration on the network. Remote computers 28 may be a personal computer, server, router, a network PC, a peer device, other common network node or the like, and may include some or all of the elements described above relative to server 22. Computer network 26 may be a local area network (LAN) and/or a wide area network (WAN), but may also include other networks. Such networking environments are commonplace in offices, enterprise-wide computer networks, intranets and the Internet. When utilized in a WAN networking environment, server 22 may include a modem or other means for establishing communications over the WAN, such as the Internet. In a networked environment, program modules or portions thereof may be stored in server 22, or database cluster 24, or on any of the remote computers 28. For example, and not limitation, various application programs may reside on the memory associated with any one or all of remote computers 28. It will be appreciated that the network connections shown are exemplary and other means of establishing a communications link between the computers may be used.

A user may enter commands and information into server 22 or convey the commands and information to the server 22 via remote computers 28 through input devices, such as keyboards, pointing devices, commonly referred to as a mouse, trackball, or touch pad. Other input devices may include a microphone, scanner, or the like. Server 22 and/or remote computers 28 may have any sort of display device, for instance, a monitor. In addition to a monitor, server 22 and/or computers 28 may also include other peripheral output devices, such as speakers and printers.

Although many other internal components of server 22 and computers 28 are not shown, those of ordinary skill in the art will appreciate that such components and their interconnection are well known. Accordingly, additional details concerning the internal construction of server 22 and computer 28 need not be disclosed in connection with the present invention. Although the method and system are described as being implemented in a LAN operating system, one skilled in the art would recognize that the method and system can be implemented in any system.

As previously mentioned, embodiments of the invention relate to an unverified order presentation mechanism. As used herein, the term “verified order” refers to a clinical order that has undergone a verification process by a pharmacist, physician, or other clinician having a designated role, which may depend on the particular clinical settings, healthcare facility/organization policies, or other pre-established rules or procedures of a healthcare organization. Conversely, the term “unverified order” refers to a clinical order that is intended to undergo but has not yet undergone a verification process by a pharmacist, physician, or other clinician having a designated role, which may depend on the particular clinical settings, healthcare facility/organization policies, or other pre-established rules or procedures of a healthcare organization.

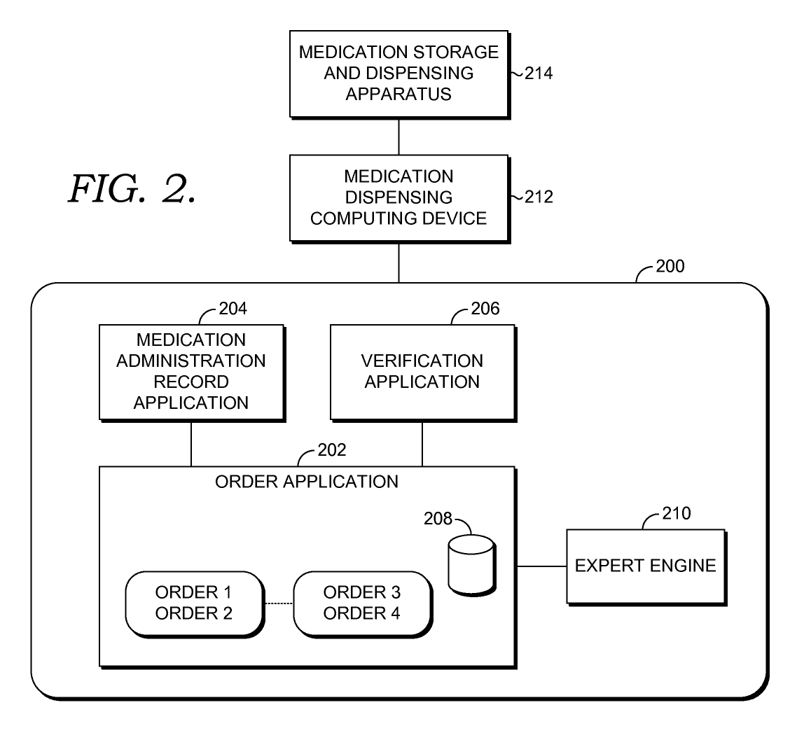

In one embodiment, the unverified order presentation mechanism operates in the context of an exemplary healthcare ordering system 200 illustrated in FIG. 2 (e.g., operating in a clinical environment supported by the architecture of the exemplary medical information system 20 of FIG. 1). The system 200 includes an order application 202, medication administration record application 204, and a verification application 206. An exemplary order application 202 is the POWERORDERS® application available from Cerner Corporation of Kansas City, Mo.

In some embodiments, the healthcare ordering system 200 operates within a comprehensive clinical computing system similar to the exemplary medical information system 20 of FIG. 1. For instance, the comprehensive clinical computing system may be provided by the MILLENIUM® healthcare information technology architecture available from Cerner Corporation of Kansas City, Mo. By operating within a comprehensive clinical computing system, a number of advantages may be realized. For example, the comprehensive clinical computing system may include computing devices and/or computing systems in a variety of different clinical domains within a healthcare environment. By way of example only and not limitation, the comprehensive clinical computing system may include a clinical laboratory system, a pharmacy system, a radiology system, and a hospital administration system. Accordingly, the comprehensive clinical computing system provides a unified computing architecture that is able to access and aggregate clinical information from a variety of different clinical domains and make the clinical information available. In an embodiment, the comprehensive clinical computing system may store clinical information from different clinical domains, as well as orders from healthcare ordering system 200, in a patient-centric electronic medical record for each patient. The patient-centric electronic medical record may include a comprehensive and current record of all health-care related information available to the healthcare organization for the patient.

In the embodiment shown in FIG. 2, the order application 202 includes a storage device 208, which may be any type of storage device including a table or database, for storing information associated with orders placed by clinicians. In some embodiments, the storage device 208 may store patient-centric electronic medical records. In some embodiments, the storage device 208 may be associated with a comprehensive clinical computing system for storing information from a variety of different clinical domains within a healthcare environment. In operation, when a clinician (care provider) places orders to be performed for a particular patient in the order application 202, information associated with the order is stored in the storage device 208. These orders are requests for medical treatment, medications, laboratory tests, etc.

The medication administration record application 204 provides for a display of medications to be administered to the patient at the point of administration, such as the patient's bedside. The verification application 206 tracks the status of medications ordered for a patient to determine if verification by the appropriate entity (e.g., pharmacy, responsible physician, etc) has occurred. Further, the system 200 may include an expert engine 210 or other component/tool to provide guidance to the clinician in the ordering process. For instance, the expert engine 210 may check for adverse drug events (ADE's) for the current order based on the particular patient's medication profile (or other information in the patient's electronic medical/health record), guide the clinician in selecting a particular drug (or drug class) and dosage to provide the desired therapeutic effect for the patient, and perform other similar activities. Although each of the applications 202, 204, 206, and 210 are shown as part of a healthcare ordering system 200, it should be understood that the applications 202, 204, 206, 210 may be part of a comprehensive clinical computing system of a healthcare organization. Additionally, other applications and components not shown in FIG. 2 may be included within the scope of embodiments of the present invention.

As shown in FIG. 2, a medication dispensing computing device 212 is interfaced with and/or integrated into the healthcare ordering system 200. In some embodiments, components of the healthcare ordering system (e.g., order application 202, medication administration record 204, verification application 206, expert engine 210) may be installed on the medication dispensing computing device 212. The medication dispensing computing device 212 is a computing device that controls the dispensing of medications from a medication storage and dispensing apparatus 214. In accordance with some embodiments, the medication dispensing computing device 212 is configured to access order information, including both verified and unverified orders, from the storage device 208. In embodiments in which the storage device 208 is part of a comprehensive clinical computing system and includes a patient-centric electronic medical record, the information available at the medication dispensing computing device 212 may reflect the real-time information available from the patient's electronic medical record.

The medication dispensing computing device 212 is configured to display medication order information, including both verified and unverified orders. The unverified orders are displayed using a visual characteristic that differs from the display of verified orders, such that a clinician can readily differentiate unverified orders from verified orders. By way of example only and not limitation, the visual characteristic may include displaying the unverified orders using a different text characteristic (e.g., different font, text size, text color, bolding, italics, etc.), applying highlighting, displaying additional text identifying the unverified status of the unverified orders, including a symbol or icon identifying the orders as being unverified, and/or separating unverified orders from verified orders.

In some embodiments, an unverified order may be used for dispensing medications from the medication storage and dispensing apparatus 214. In particular, the medication dispensing computing device 212 may display an unverified order and allow for selection of the unverified order by a clinician, thereby causing medication associated with the unverified order to be dispensed from the medication storage and dispensing apparatus 214. In some embodiments, rules may be applied to control dispensing of medications for unverified orders. For instance, in some embodiment, the rules may prevent dispensing medications associated with any unverified order. In other embodiments, the rules may prevent medication for some unverified orders from being dispensed while allowing medication for other unverified orders to be dispensed. By way of example only and not limitation, the rules may be based on the type of medication associated with an unverified order, the role of the clinician attempting to access the medication, and the location of the medication storage and dispensing apparatus 214 within a healthcare organization (maternity ward, ICU, etc.). In such embodiments, different visual characteristics may be applied to differentiate unverified orders for which medications can be dispensed (i.e., “dispensable unverified medication orders”) from unverified orders for which medications cannot be dispensed (i.e., “non-dispensable unverified medication orders”).

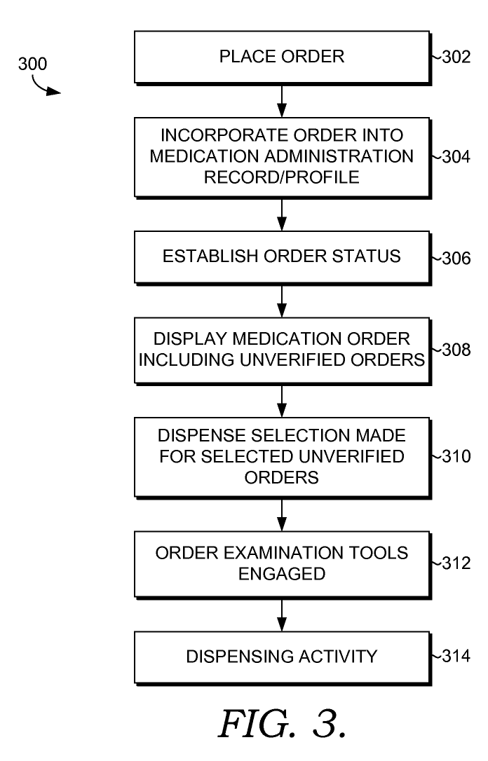

With reference now to FIG. 3, a flow diagram is provided illustrating an exemplary method 300 for presenting unverified orders alongside verified orders at a medication dispensing computing device (e.g., the medication dispensing computing device 212 of FIG. 2) used for dispensing medications from a medication storage and dispensing apparatus (e.g., the medication storage and dispensing apparatus 214 of FIG. 2). The unverified orders and verified orders may be obtained, for instance, from a particular patient's medication profile or electronic medical record (e.g., from storage device 208 of FIG. 2).

According to the method, in step 302, a clinician places an order for a particular patient (e.g., using the order application 202 of FIG. 2). In some embodiments, this may involve the expert engine 210 of FIG. 2 or other mechanism providing order guidance to the clinician (e.g., suggestions, interaction checking, etc.). The order, in step 304, is then incorporated in the patient's medication administration record or profile, electronic medical record, or other patient record, for instance, via the medication administration record application 204 of FIG. 2. As shown at step 306, the status of the particular order is established as “verified” or “unverified”, for instance, by the verification application 206 of FIG. 2. Typically, many or all types of medication orders are originally classified as “unverified” by default in certain clinical settings (e.g., acute care/in-patient settings). In embodiments, the verification application 206 continually monitors the verification status to determine if an authorized entity (e.g., a pharmacist in the pharmacy) has indeed verified the order. In an alternative embodiment, the verification application 206 tracts the verification status, but another component (e.g., a pharmacy application) actually makes the verification determination (e.g., after receiving clinician input) and feeds such information to the verification application 206.

In step 308, medication orders for the patient are displayed at a medication dispensing computing device used for controlling the dispensing of medications from a medication storage and dispensing apparatus. The medication orders are displayed on a user interface with a particular visual characteristic applied to the listing of any unverified order to differentiate such an order from other verified orders displayed. By way of example only and not limitation, an exemplary user interface may include a particular label to indicate to the clinician that a particular order is unverified.

As indicated previously, in some embodiments, a clinician may employ an unverified order for selecting a medication to dispense from a medication storage and dispensing apparatus. For instance, as shown at step 310, a clinician or other user designated as authorized to retrieve a particular medication may make a “dispense” selection on an interactive element of the user interface in association with the selected unverified order for the particular patient. For instance, as one example, a particular unverified order on the medication administration record or profile may be selected by any means (e.g., clicked on or scrolled to by the user), and then designated for dispensing by selecting a “remove” button. Whether a “dispense” selection is allowed for an unverified order may depend on various rules established by a healthcare organization in which the healthcare ordering system resides. For instance, the ability to make a dispense selection for medication removal may depend on the particular role of the clinician removing/administering the medication from the unverified order, the type of medication associated with the order (e.g., a controlled substance), or the location within the healthcare organization at which the dispensing is requested (e.g., maternity ward, ICU, etc.). It may also depend on having a witness authorize themselves with the system at the time the clinician making the removal request is attempting to make the “dispense” selection or otherwise is viewing the unverified order.

In some embodiments, as shown at step 312, various order examination tools are engaged (e.g., through expert engine 210 of FIG. 2) upon the “dispense” selection being made. For instance, the order examination tools may check for adverse drug event risk, such as drug-drug interactions, or known allergies of the particular patient, as well as whether this particular order may be a duplicate in the system. Because the particular unverified order may have been placed well before the time of dispensing, any order checking for adverse drug event risk and the like may have become “stale” or otherwise inaccurate when the time arrives for actual medication dispensing. At step 314, a dispensing activity is then undertaken by a medication storage and dispensing apparatus associated with the medication dispensing computing apparatus. In particular, a medication corresponding with the selected unverified order is dispensed from the medication storage end dispensing apparatus for administration to the patient by the clinician.

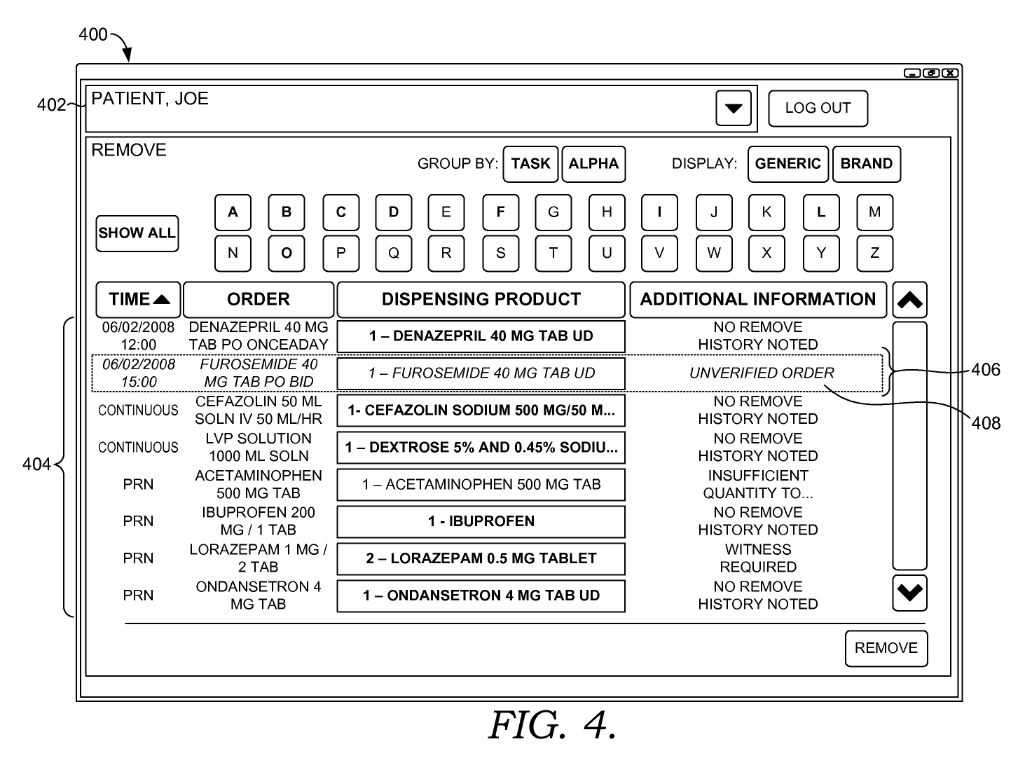

Embodiments of the present invention will now be described with reference to FIGS. 4-6B, which include exemplary screen displays providing unverified orders with verified orders at a medication dispensing computing device. It will be understood and appreciated by those of ordinary skill in the art that the screen displays of FIGS. 4-6B are provided by way of example only and are not intended to limit the scope of the present invention in any way.

With reference initially to FIG. 4, an illustrative interactive screen display (user interface) 400 is shown. In accordance with an embodiment of the present invention, generally, exemplary user interface 400 identifies a patient 402 and includes an order list 404, which forms a medication administration record or profile for the particular patient. The order list 404 includes the medications prescribed for and/or taken by the patient within a particular time period, such as, for instance, for the current patient encounter with the given healthcare venue. The order list 404 includes verified medication orders as well as the unverified medication order 406. The user interface 400 also includes a visual characteristic designed to differentiate the unverified order 406 from other orders. For instance, in the embodiment of FIG. 4, the unverified medication order 406 is displayed using italics and a particular label 408 with the text “UNVERIFIED ORDER” has been applied to give a clinician an indication that the particular order 406 on the medication administration record or profile is unverified. As discussed previously, in various embodiments, other visual characteristics such as icons and various graphical elements may be used as a substitute for or in addition to the italics and label 408 shown in FIG. 4. Optionally, if rules allow the user to designate for removal a particular unverified order selected from the order list 404, the user may select the “Remove” button 410, as an interactive element to initiate the dispensing of the associated medication dose.

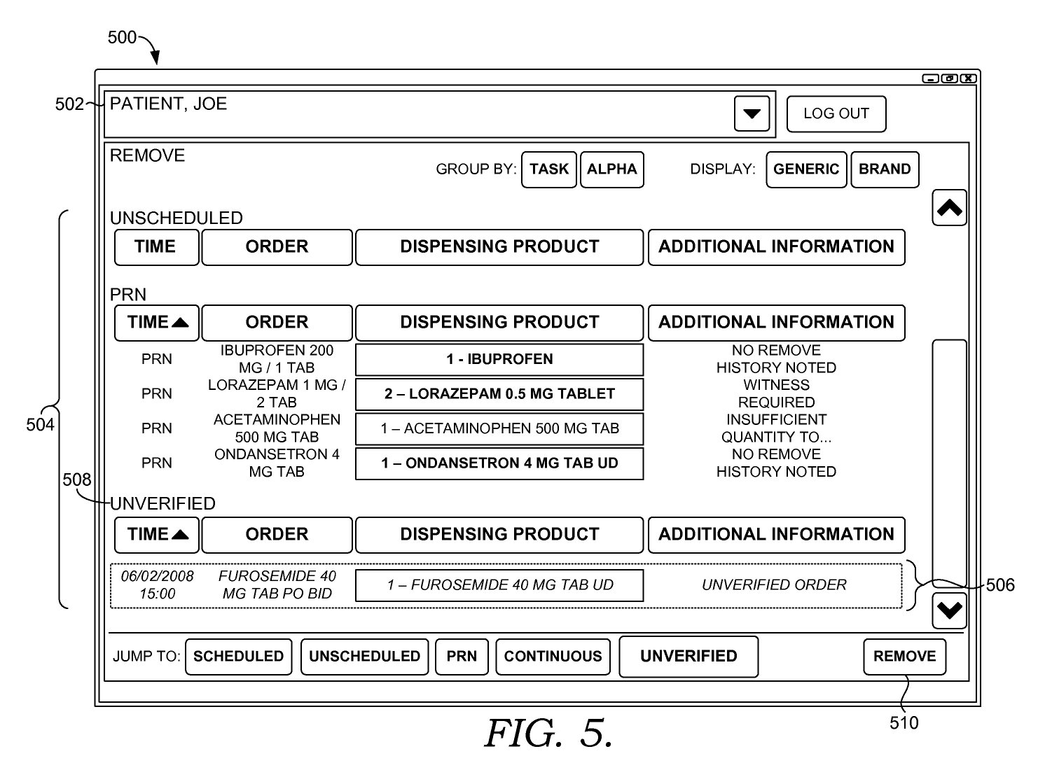

Turning now to FIG. 5, an illustrative interactive screen display (user interfaces) 500 in accordance with another embodiment of the present invention is shown. Similar to the embodiment shown in FIG. 4, the exemplary user interface 500 identifies a patient 502 and includes an order list 504, which forms a medication administration record or profile for the particular patient. The order list 504 includes the medications prescribed for and/or taken by the patient within a particular time period, such as, for instance, for the current patient encounter with the given healthcare venue. In the embodiment of FIG. 5, the order list is broken into different groups, including scheduled orders, unscheduled orders, PRN orders, continuous orders and unverified orders. As such, in the embodiment of FIG. 5, an unverified order 506 is identified as being unverified by placing the unverified order 506 in the unverified order grouping 508. As such, the visual characteristic used to identify unverified orders may simply be placing the unverified orders in a separate grouping. Optionally, if rules allow the user to designate for removal a particular unverified order selected from the order list 504, the user may select the “Remove” button 510, as an interactive element to initiate the dispensing of the associated medication dose.

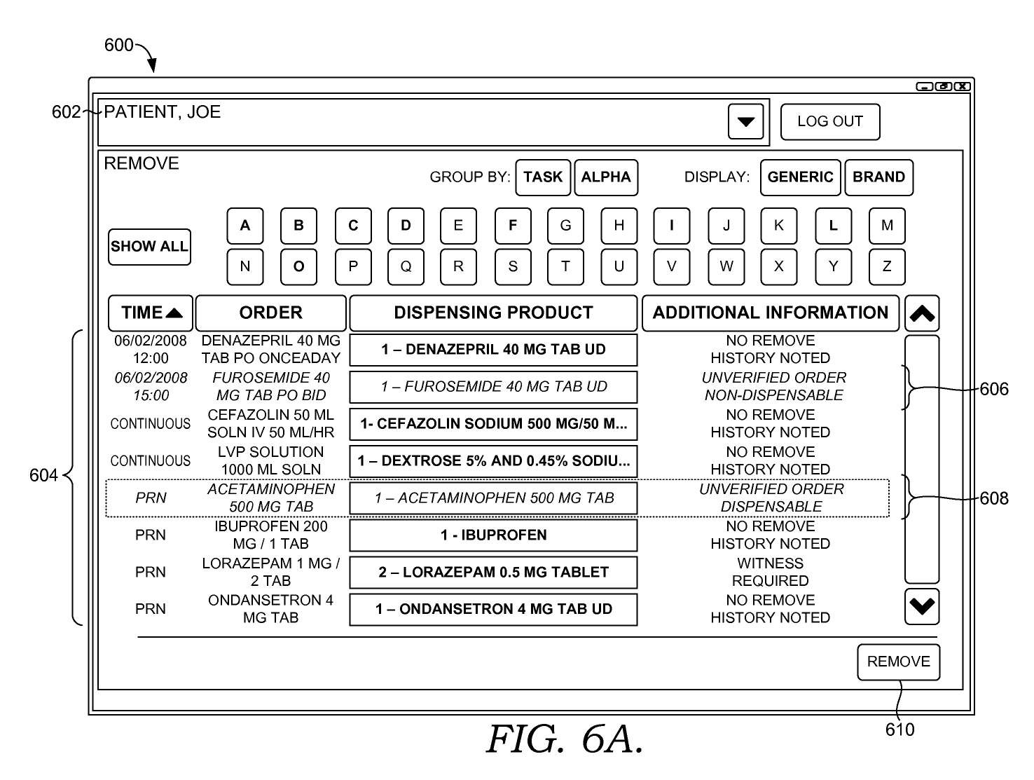

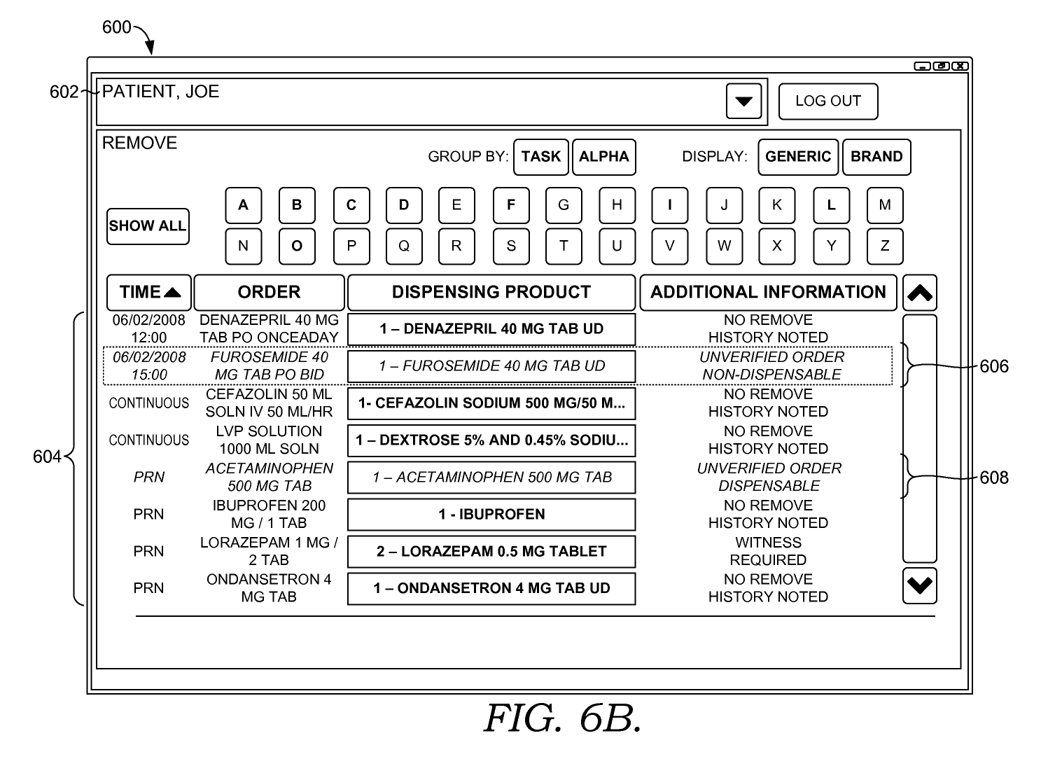

As discussed previously, in some embodiments, some unverified medication orders may be identified as being “dispensable” (i.e., the order may be selected for dispensing an associated medication) while other orders may be identified as being “non-dispensable” (i.e., the order may not be selected for dispensing an associated medication). FIGS. 6A and 6B illustrate an interactive screen display (user interfaces) 600 that include verified medication orders and unverified medication orders that include both dispensable and non-dispensable orders. Similar to the embodiments shown in FIGS. 4 and 5, the exemplary user interface 600 identifies a patient 602 and includes an order list 604, which forms a medication administration record or profile for the particular patient. The order list 604 includes the medications prescribed for and/or taken by the patient within a particular time period, such as, for instance, for the current patient encounter with the given healthcare venue. The order list 604 includes verified medication orders as well as the unverified medication orders 606 and 608. The user interface 600 also includes a visual characteristic designed to differentiate the unverified orders 606 and 608 from other verified orders. For instance, in the embodiment of FIG. 6, the unverified medication orders 606 and 608 are displayed using italics and each include the text “UNVERIFIED ORDER.” Additionally, a visual characteristic has been applied to indicate the unverified medication order 606 as being non-dispensable and the unverified medication order 608 as being dispensable. In particular, the unverified medication order 606 includes the text “NON-DISPENSABLE,” while the unverified medication order 608 includes the text “DISPENSABLE.” In various embodiments, other visual characteristics may be used to differentiate dispensable unverified medication orders from non-dispensable unverified medication orders.

As shown in FIG. 6A, when the dispensable unverified medication order 608 is selected, a “Remove” button 610 is available for selection. As such, the user may select the “Remove” button 610 to initiate dispensing of associated medication from a medication storage and dispensing apparatus. Alternatively, as shown in FIG. 6B, when the non-dispensable unverified medication order 606 is selected, no “Remove” button is available. In some embodiments, a “Remove” button may be displayed but may be non-selectable. As such, the user may not initiate dispensing of medication associated with the non-dispensable unverified medication order 606.

Thus, the various embodiments of the invention provide an unverified order presentation mechanism allowing clinicians to view unverified orders alongside verified orders in a particular patient's medication profile. It will be understood that certain features and sub-combinations of utility may be employed without reference to features and sub-combinations and are contemplated within the scope of the claims. Furthermore, the steps performed need not be performed in the order described.

What is claimed is:

1. One or more computer-storage media storing computer-useable instructions for causing a computing device to perform a method of displaying verified and unverified medication orders, the computing device being operable to control dispensing of medications from a medication storage and dispensing apparatus, the method comprising:
accessing medication order information associated with a patient, the medication order information including one or more verified medication orders and one or more unverified medication orders; and
displaying at least a portion of the medication order information, wherein each of the one or more unverified medication orders is displayed using at least one visual characteristic that identifies the one or more unverified orders as having an unverified status.

2. The one or more computer-storage media of claim 1, wherein the order information is accessed from an electronic medical record for the patient maintained by a comprehensive clinical computing system operable to collect data from a plurality of clinical domains within a healthcare organization.

3. The one or more computer-storage media of claim 1, wherein the at least one visual characteristic comprises at least one selected from the following: a text font, a text size, a text color, an icon, a symbol, and additional text specifying the unverified status.

4. The one or more computer-storage media of claim 1, wherein the method further comprises preventing selection of each of the one or more unverified medication orders, thereby prevention dispensing medication associated with the one or more unverified medication orders from the medication storage and dispensing apparatus.

5. The one or more computer-storage media of claim 1, wherein the method further comprises:
identifying a first unverified medication order from the one or more unverified medication orders as having a non-dispensable medication status; and
preventing a first medication associated with the first unverified medication order from being dispensed based on the non-dispensable medication status.

6. The one or more computer-storage media of claim 5, wherein the method further comprises:
identifying a second unverified medication order from the one or more unverified medication orders as having a dispensable medication status; and
allowing a second medication associated with the second unverified medication order to be dispensed based on the dispensable medication status.

7. The one or more computer-storage media of claim 6, wherein the first unverified medication order is displayed using a first visual characteristic and the second unverified medication order is displayed using a second visual characteristic, wherein the first visual characteristic is different from the second visual characteristic, thereby facilitating user identification of the first unverified medication order as having the non-dispensable medication status and the second unverified medication order as having the dispensable medication status.

8. The one or more computer-storage media of claim 7, wherein the first unverified medication order is identified as having the non-dispensable medication status and the second unverified medication order is identified as having the dispensable medication status based one or more rules for determining whether medication associated with a particular unverified medication order can be dispensed.

9. The one or more computer-storage media of claim 8, wherein the one or more rules determine whether medication associated with a particular unverified medication order can be dispensed based on one or more selected from the following factors: a type of medication associated with the particular unverified medication order, a role of a clinician attempting to access medication associated with the particular unverified medication order, and a location of the medication storage and dispensing apparatus.

10. One or more computer-storage media storing computer-useable instructions for causing a computing device to perform a method of using an unverified medication order for dispensing a medication, the computing device being operable to control dispensing of medications from a medication storage and dispensing apparatus, the method comprising:
displaying a list of medication orders for a patient, wherein the list of medication orders includes one or more verified medication orders and one or more unverified medication orders, and wherein each of the one or more unverified medication orders is displayed using a visual characteristic that identifies the one or more unverified medication orders as having an unverified status;
receiving a selection of an unverified medication order from the list of medication orders; and
responsive to the selection, causing a medication associated with the selected unverified medication order to be dispensed from the medication storage and dispensing apparatus.

11. The one or more computer-storage media of claim 10, wherein the method further comprises:
receiving a new medication order for the patient;
identifying the new medication order as having an unverified status;
storing the new medication order in an electronic medical record associated with the patient; and
updating the displayed list of medication orders by adding the new medication order from the electronic medical record, wherein the new medication order is displayed using the visual characteristic identifying the new medication order as having the unverified status.

12. The one or more computer-storage media of claim 10, wherein the method further comprises determining that the selected unverified medication order is associated with a dispensable medication.

13. The one or more computer-storage media of claim 10, wherein the method further comprises receiving a second selection of a second unverified medication order from the list of medication orders;
identifying the second unverified medication order as being associated with a non-dispensable medication; and
based on identifying the second unverified medication order as being associated with a non-dispensable medication, preventing a second medication associated with the second unverified medication order from being dispensed from the medication storage and dispensing apparatus.

14. The one or more computer-storage media of claim 13, wherein the second unverified medication order is displayed using a second visual characteristic that identifies the second medication order as having an unverified status and as being associated with a non-dispensable medication.

15. The one or more computer-storage media of claim 10, wherein the visual characteristic comprises at least one selected from the following: a text font, a text size, a text color, an icon, a symbol, and additional text specifying the unverified status.

16. One or more computer-storage media storing computer-useable instructions for presenting one or more user interfaces for displaying a medication profile for a particular patient in a particular healthcare encounter, the one or more user interfaces comprising:
an order list including medication orders associated with medications prescribed for the particular patient; and
a visual characteristic associated with one or more particular medication orders of the order list to indicate said one or more particular medication orders possesses the status of an unverified order.

17. The one or more computer-storage media of claim 16, wherein the user interface further comprises:
a user-selectable interactive element for selecting a particular medication order of the order list having the status of an unverified order to be dispensed.

18. The one or more computer-storage media of claim 16 wherein information regarding the medication orders is accessed from an electronic medical record for the patient maintained by a comprehensive clinical computing system operable to collect data from a plurality of clinical domains within a healthcare organization.

19. The one or more computer-storage media of claim 16, wherein the visual characteristic comprises at least one selected from the following: a text font, a text size, a text color, an icon, a symbol, and additional text specifying the unverified status.

20. The one or more computer-storage media of claim 16, wherein the user interface further comprises:
a second visual characteristic associated with at least one of the one or more particular medication orders of the order list to indicate said at least one of the one or more particular medication orders is associated with a non-dispensable medication.
